(19) United States
(12) Patent Application Publication
(10) Pub. No.: US 2013/0218675 A1
(43) Pub. Date: Aug. 22, 2013

(54) MOBILE DEDICATED GIFT TOKEN MANAGEMENT SYSTEM

(71) Applicant: HAPPY MONEY I.N.C. CO., LTD., (US)

(72) Inventor: Byeong Ho CHOI, Seoul (KR)

(73) Assignee: HAPPY MONEY I.N.C. CO., LTD., Seoul (KR)

(21) Appl. No.: 13/754,390

(22) Filed: Jan. 30, 2013

(30) Foreign Application Priority Data
Feb. 16, 2012 (KR) 10-2012-0016046

(51) Int. Cl. G06Q 20/36

(52) U.S. Cl. CPC G06Q 20/367
USPC 705/14.51

(57) ABSTRACT

Disclosed is a mobile dedicated gift token management system capable of providing a mobile dedicated gift token of using in only the specific member store designated by a customer through a website or a dedicated access terminal of selling the dedicated gift token to a mobile terminal designated by the customer. Also, an expiration date setting unit for setting the term of validity is constructed, thereby restricting an improper use thereof.

### BACKGROUND OF THE INVENTION

1. Field of the Invention

The present invention relates to a mobile dedicated gift token management system. More particularly, the present invention relates to a mobile dedicated gift token management system capable of providing a mobile dedicated gift token of using in only the specific member store designated by a customer to a mobile terminal designated by the customer.

2. Description of the Prior Art

A coupon calls discount coupons of goods/services or tokens of goods/services for advertizing the goods or the services.

Generally, the coupon is made from a paper. However, recently, since the mobile communication services become popular, a bar code downloaded by the mobile terminal can perform the function of the coupon. Also, the kind of the mobile coupon is diversified.

The procedure of downloading the conventional mobile coupon to the mobile terminal will be described herein below.

Firstly, where the mobile coupon of the member store is posted on the website etc. together with the goods information by means of the network provider, the user finds out the access number capable of downloading the coupon through the website. Thereafter, the user downloads the mobile coupon to the mobile terminal through a WAP (Wireless Application Protocol) etc. or the posted mobile coupon can be transmitted to the mobile terminal through a PC according to the request of the user.

In the conventional mobile coupon providing method, the user directly visits the website for providing the mobile coupon and checks out the member store for providing the coupon one by one and then, it goes through a predetermined process. However, since there are so many member stores, it is a quite cumbersome to check out the member store one by one. Also, it is a problem in that any system for using it in only the desiring member store is not provided.

Also, since the conventional mobile gift token can be used within the designated expiration date, it can be wrongfully used in an improper deal. Moreover, since the user cannot provide separated sentences or images besides the coupon image, there is a problem in that it cannot make good use of the public relations of the enterprise or the user.

### SUMMARY OF THE INVENTION

Accordingly, the present invention has been made to solve the above-mentioned problems occurring in the prior art, and an object of the present invention is to provide a mobile dedicated gift token management system capable of providing a mobile dedicated gift token of using in only the specific member store designated by a customer through a website or a dedicated access terminal of selling the dedicated gift token to a mobile terminal designated by the customer.

Another object of the present invention is to provide a mobile dedicated gift token management system in that an expiration date setting unit for setting the term of validity is constructed, thereby restricting an improper use thereof.

Further another object of the present invention is to provide a mobile dedicated gift token management system in that sentences or image information designated by an user terminal connected to a homepage or a dedicated access terminal are obtained and they are matched to the predetermined area established within the generated coupon image in advance, thereby making good use of the public relations of the enterprise or the user.

In order to accomplish these objects, there is provided a mobile dedicated gift token management system, comprising: a dedicated gift token management server for designating a code grant and an use place to a dedicated gift token sold through a dedicated gift token site of a homepage and transmitting a message of a coupon corresponding to the dedicated gift token to a mobile terminal offered in a case that it orders the dedicated gift token though the homepage; and the mobile terminal for receiving the message from the dedicated gift token management server and outputting a coupon image on a monitor.

Preferably, the dedicated gift token management server comprises: a dedicated gift token information database for storing and managing dedicated gift token information sold through the dedicated gift token site therein; a dedicated code assignment unit for assigning the code to the dedicated gift token and transmitting the assigned code information to the dedicated gift token information database to be stored therein; a dedicated use place designation unit for designating the use place of using the dedicated gift token and transmitting the designated use place information to the dedicated gift token information database to be stored therein; a dedicated gift token information providing unit for providing the dedicated gift token information stored in the dedicated gift token information database to the web server of managing the homepage; an use place information database for storing and managing the use place information of using the dedicated gift token and the coupon image information; a mobile terminal information obtaining unit for obtaining the mobile terminal information in a case that it orders the dedicated gift token though the homepage; a dedicated gift token coupon generation unit for generating the dedicated gift token coupon as the coupon image corresponding to the dedicated gift token obtained by the mobile terminal information obtaining unit; a dedicated gift token coupon transmittance unit for transmitting the dedicated gift token coupon generated by the dedicated gift token coupon generation unit to a mobile number of the mobile terminal obtained by the mobile terminal information obtaining unit by means of the message; and a dedicated gift token management controlling unit for controlling signal flows between each database and each unit.

In order to accomplish these objects, there is provided another mobile dedicated gift token management system, comprising: a dedicated gift token management server for designating a code grant and an use place to a dedicated gift token requested from a dedicated access terminal and transmitting a message of a coupon corresponding to the dedicated gift token to a mobile terminal offered through the dedicated access terminal in a case that it orders the dedicated gift token; and the mobile terminal for receiving the message from the dedicated gift token management server and outputting a coupon image on a monitor.

Preferably, the dedicated gift token management server comprises: a dedicated gift token information database for storing and managing dedicated gift token information sold through the dedicated gift token site therein; a dedicated code assignment unit for assigning the code to the dedicated gift token and transmitting the assigned code information to the dedicated gift token information database to be stored therein; a request dedicated gift token information obtaining unit for obtaining the dedicated gift token information requested from the dedicated access terminal; a dedicated use place designation unit for designating the use place of using the dedicated gift token requested from the dedicated access terminal and transmitting the designated use place information to the dedicated gift token information database to be stored therein; an use place information database for storing and managing the use place information of using the dedicated gift token and the coupon image information; a mobile terminal information obtaining unit for obtaining the mobile terminal information obtained the request dedicated gift token information obtaining unit; a dedicated gift token coupon generation unit for generating the dedicated gift token coupon as the coupon image corresponding to the dedicated gift token obtained by the mobile terminal information obtaining unit; a dedicated gift token coupon transmittance unit for transmitting the dedicated gift token coupon generated by the dedicated gift token coupon generation unit to a mobile number of the mobile terminal obtained by the mobile terminal information obtaining unit by means of the message; and a dedicated gift token management controlling unit for controlling signal flows between each database and each unit.

Preferably, the mobile terminal comprises: a message receiving unit for receiving the message from the dedicated gift token management server; a coupon downloading unit for downloading the corresponding coupon image received from the message receiving unit; a coupon image outputting unit for outputting the downloaded coupon image on the monitor; and a coupon storing unit for storing the coupon downloaded through coupon downloading unit therein.

Preferably, the message including a callback URL SMS or a WAP PUSH (Wireless Application Protocol Push) is transmitted to a phone number of the desiring mobile terminal in the dedicated gift token coupon transmittance unit.

Preferably, the dedicated gift token management server further comprises an expiration date setting unit for setting the term of validity.

Preferably, the dedicated gift token management server further comprises: an user designation information obtaining unit for obtaining sentences or image information designated by the user terminal connected to the homepage or the dedicated access terminal; and an user designation information matching unit for receiving the sentences or the image information obtained by the user designation information obtaining unit and matching them to a predetermined area established within the coupon image generated by the dedicated gift token coupon generation unit.

### BRIEF DESCRIPTION OF THE DRAWINGS

The above and other objects, features and advantages of the present invention will be more apparent from the following detailed description taken in conjunction with the accompanying drawings, in which:

FIG. 1 is an entire block diagram illustrating a mobile dedicated gift token management system according to one embodiment of the present invention;

FIG. 2 is a block diagram illustrating a dedicated gift token management server of a mobile dedicated gift token management system according to one embodiment of the present invention;

FIG. 3 is a block diagram illustrating a mobile terminal of a mobile dedicated gift token management system according to one embodiment of the present invention;

FIG. 4 is an entire block diagram illustrating a mobile dedicated gift token management system according to another embodiment of the present invention;

FIG. 5 is a block diagram illustrating a dedicated gift token management server of a mobile dedicated gift token management system according to another embodiment of the present invention;

FIG. 6 is an exampling view illustrating a procedure of a mobile dedicated gift token management system according to the present invention; and

FIG. 7A through FIG. 7C are exampling views illustrating images of the corresponding coupons of sending to the mobile terminal through a mobile dedicated gift token management system according to the present invention.

### DETAILED DESCRIPTION OF THE PREFERRED EMBODIMENTS

Hereinafter, an exemplary embodiment of the present invention will be described in detail with reference to the accompanying drawings.

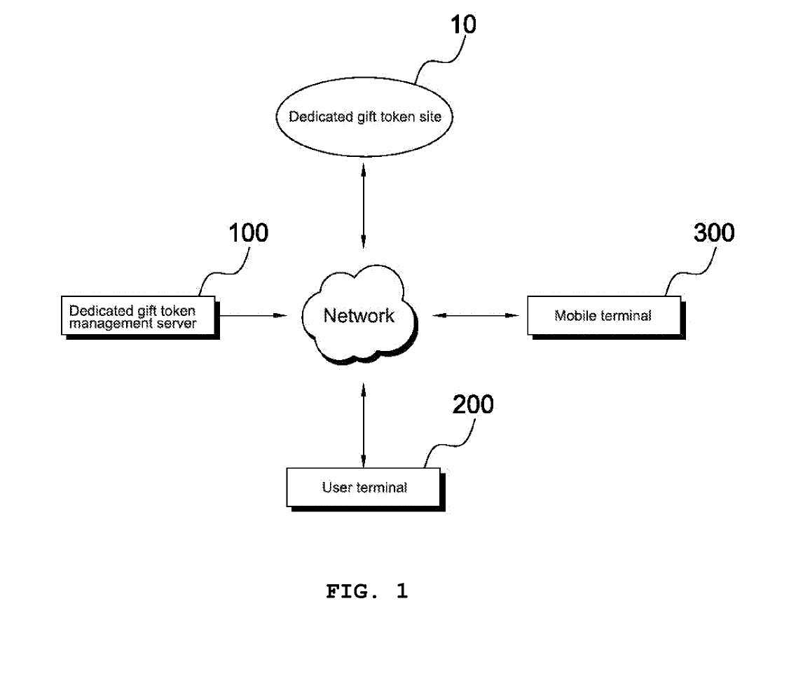

FIG. 1 is an entire block diagram illustrating a mobile dedicated gift token management system according to one embodiment of the present invention.

As shown in FIG. 1, the mobile dedicated gift token management system according to one embodiment of the present invention includes:

a dedicated gift token management server 100 for designating a code grant and an use place to a dedicated gift token sold through a dedicated gift token site 10 of a homepage and transmitting a message of a coupon corresponding to the dedicated gift token to a mobile terminal offered in a case that it orders the dedicated gift token though the homepage; and

the mobile terminal 300 for receiving the message from the dedicated gift token management server 100 and outputting a coupon image on a monitor.

That is, the mobile dedicated gift token management system according to one embodiment of the present invention includes the user terminal 200, the mobile terminal 300, the network, the dedicated gift token management server 100, and the web server (not shown) for managing the dedicated gift token site 10.

Here, the coupon of the mobile dedicated gift token means discount coupons of goods/services or tokens of goods/services which can be used in the member store. Also, the coupon of the mobile dedicated gift token means any bar code etc. which can be stored as a file type in the mobile terminal and displayed to outside.

Also, the user terminal 200 can mean various computer terminals for visiting the dedicated gift token site 10. Moreover, the user terminal 200 can mean the mobile terminal 300.

The mobile terminal 300 means any means for storing the coupon of the dedicated gift token generated from the dedicated gift token management server 100 and displaying it to the outside. That is, the mobile terminal 300 is any terminal having a terminal number inputted by the user through the user terminal.

Also, the dedicated gift token described in the present invention means any gift token among the bard code gift tokens capable of using it in only the designated use place during sale thereof.

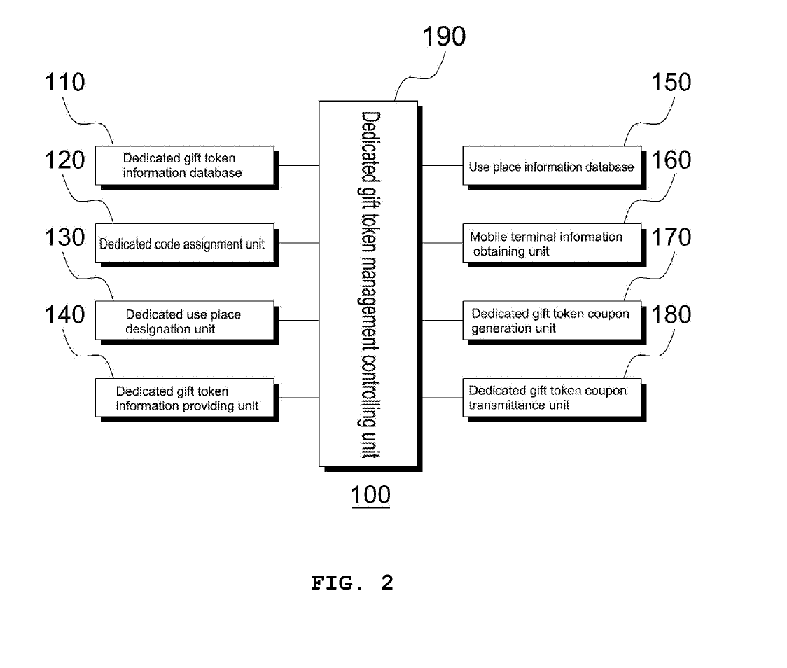

FIG. 2 is a block diagram illustrating a dedicated gift token management server of a mobile dedicated gift token management system according to one embodiment of the present invention.

As shown in FIG. 2, the dedicated gift token management server 100 includes:

a dedicated gift token information database 110 for storing and managing dedicated gift token information sold through the dedicated gift token site 10 therein;

a dedicated code assignment unit 120 for assigning the code to the dedicated gift token and transmitting the assigned code information to the dedicated gift token information database 110 to be stored therein;

a dedicated use place designation unit 130 for designating the use place of using the dedicated gift token and transmitting the designated use place information to the dedicated gift token information database 110 to be stored therein;

a dedicated gift token information providing unit 140 for providing the dedicated gift token information stored in the dedicated gift token information database 110 to the web server of managing the homepage;

an use place information database 150 for storing and managing the use place information of using the dedicated gift token and the coupon image information;

a mobile terminal information obtaining unit 160 for obtaining the mobile terminal information in a case that it orders the dedicated gift token though the homepage;

a dedicated gift token coupon generation unit 170 for generating the dedicated gift token coupon as the coupon image corresponding to the dedicated gift token obtained by the mobile terminal information obtaining unit 160;

a dedicated gift token coupon transmittance unit 180 for transmitting the dedicated gift token coupon generated by the dedicated gift token coupon generation unit 170 to a mobile number of the mobile terminal obtained by the mobile terminal information obtaining unit 160 by means of the message; and

a dedicated gift token management controlling unit 190 for controlling signal flows between each database and each unit.

The dedicated gift token management server 100 has any construction for selling the dedicated gift token though a dedicated gift token shop of the homepage.

The dedicated code assignment unit 120 serves to assign the code to the dedicated gift token and transmit the assigned code information to the dedicated gift token information database 110 to be stored therein.

For example, the code No. “974” can be assigned to the dedicated gift token.

The dedicated use place designation unit 130 serves to designate the use place of using the dedicated gift token and transmit the designated use place information to the dedicated gift token information database 110 to be stored therein.

For example, if the use place is designated as a convenience store “GS25”, the dedicated gift token can be used in only the convenience store “GS25”.

The dedicated gift token information database 110 serves to store and manage the dedicated gift token information sold through the dedicated gift token site 10 therein.

That is, the code No. “974” assigned by the dedicated code assignment unit 120 and the convenience store “GS25” designated by the dedicated use place designation unit 130 are stored in a data field of the dedicated gift token information database 110.

Generally, the dedicated gift token information may be a kind of the dedicated gift token, a number of the dedicated gift token, a cash charging status, a kind of a paper money, a selling price, an image of the coupon, a logo of the coupon, and a member store information and so on.

The dedicated gift token information providing unit 140 serves to provide the dedicated gift token information stored in the dedicated gift token information database 110 to the web server of managing the homepage. Also, the dedicated gift token information providing unit 140 serves to designate the use place of the dedicated gift token by means of the website access through the user terminal 200.

The use place information database 150 serves to store and manage the use place information of using the dedicated gift token and the coupon image information.

That is, the use place and the coupon image information provided in the corresponding use place are obtained in the dedicated gift token management controlling unit 190 to be stored therein.

The mobile terminal information obtaining unit 160 serves to obtain the mobile terminal information in a case that it orders the dedicated gift token though the homepage.

That is, the user terminal 200 serves to designate the number of the mobile terminal 300 for receiving the corresponding coupon, thereby obtaining the assigned number.

The dedicated gift token coupon generation unit 170 serves to generate the dedicated gift token coupon as the coupon image corresponding to the dedicated gift token obtained by the mobile terminal information obtaining unit 160.

The dedicated gift token coupon generation unit 170 can further include a bar code generation module for generating the mobile coupon in the type of a bar code.

The dedicated gift token coupon transmittance unit 180 serves to transmit the dedicated gift token coupon generated by the dedicated gift token coupon generation unit 170 to a mobile number of the mobile terminal obtained by the mobile terminal information obtaining unit 160 by means of the message. The message including a callback URL SMS or a WAP PUSH (Wireless Application Protocol Push) can be transmitted to the phone number of the desiring mobile terminal.

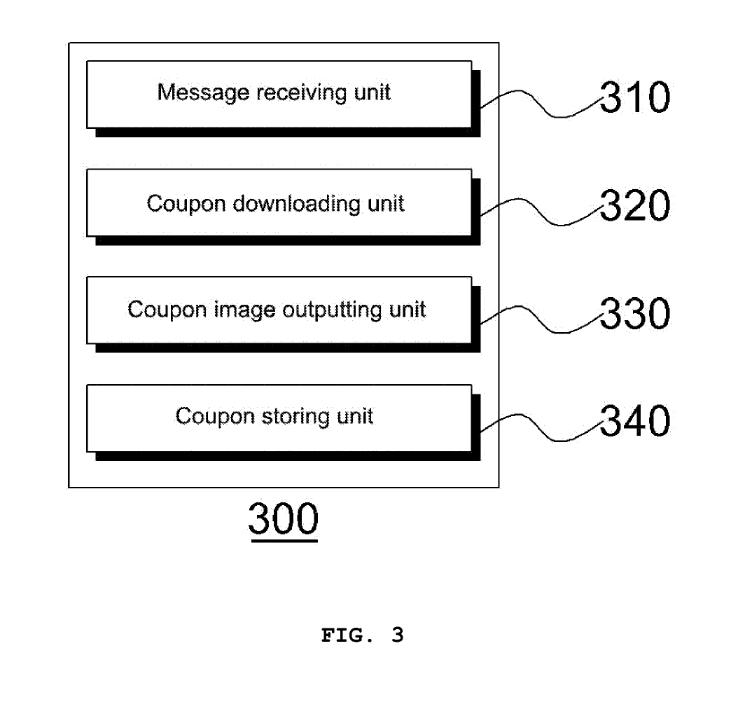

FIG. 3 is a block diagram illustrating a mobile terminal of a mobile dedicated gift token management system according to one embodiment of the present invention.

As shown in FIG. 3, the mobile terminal 300 includes:

a message receiving unit 310 for receiving the message from the dedicated gift token management server 100;

a coupon downloading unit 320 for downloading the corresponding coupon image received from the message receiving unit 310;

a coupon image outputting unit 330 for outputting the downloaded coupon image on the monitor; and

a coupon storing unit 340 for storing the coupon downloaded through coupon downloading unit 320 therein.

That is, in the message receiving unit 310, the message transmitted from the dedicated gift token management server 100 is received.

Where the user checks out the corresponding message, in the coupon downloading unit 320, the corresponding coupon image received from the message receiving unit 310 is downloaded.

Also, the downloaded coupon image downloaded by the coupon downloading unit 320 is displayed on the monitor through the coupon image outputting unit 330.

The coupon downloaded through coupon downloading unit 320 is stored in the coupon storing unit 340. The stored coupon can be utilized in a time of need.

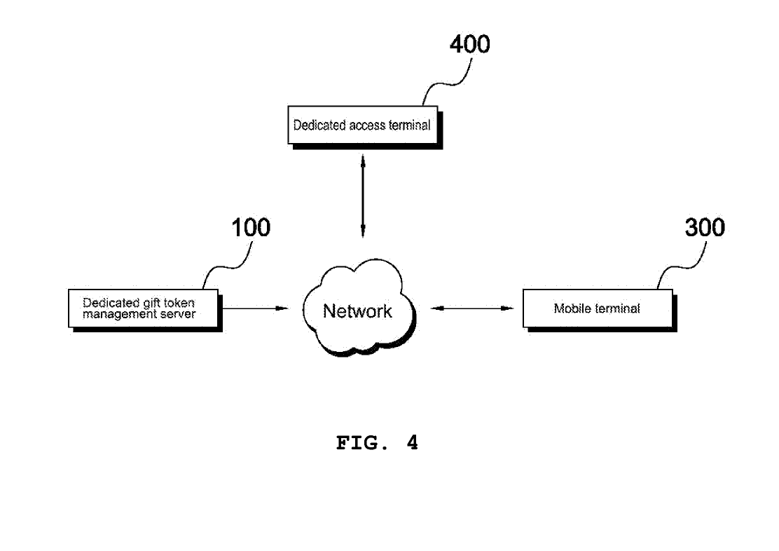

FIG. 4 is an entire block diagram illustrating a mobile dedicated gift token management system according to another embodiment of the present invention.

As shown in FIG. 4, the mobile dedicated gift token management system according to another embodiment of the present invention includes:

a dedicated gift token management server 100 for designating a code grant and an use place to a dedicated gift token requested from a dedicated access terminal 400 and transmitting a message of a coupon corresponding to the dedicated gift token to a mobile terminal offered through the dedicated access terminal 400 in a case that it orders the dedicated gift token; and

the mobile terminal 300 for receiving the message from the dedicated gift token management server 100 and outputting a coupon image on a monitor.

That is, the mobile dedicated gift token management system according to another embodiment of the present invention includes the dedicated access terminal 400, the mobile terminal 300, the network, and the dedicated gift token management server 100.

The mobile dedicated gift token management system according to another embodiment of the present invention can provide the dedicated gift token requested from the dedicated access terminal 400.

To achieve this, it is necessary to construct a separate dedicated internet access mall. Accordingly, it can provide the dedicated gift token in accordance with the request of the dedicated access terminal 400, which is connected to the corresponding dedicated internet access mall.

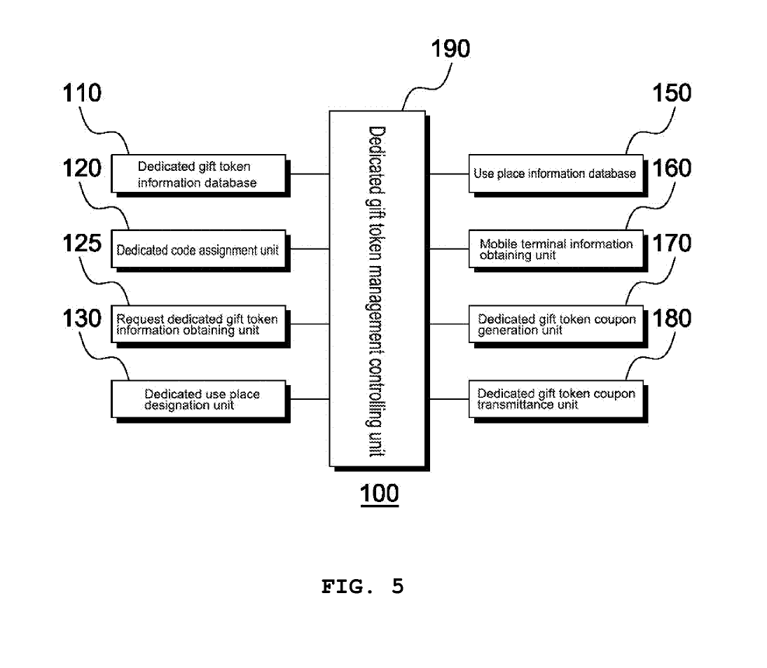

FIG. 5 is a block diagram illustrating a dedicated gift token management server of a mobile dedicated gift token management system according to another embodiment of the present invention.

As shown in FIG. 5, the dedicated gift token management server 100 includes:

a dedicated gift token information database 110 for storing and managing dedicated gift token information sold through the dedicated gift token site 10 therein;

a dedicated code assignment unit 120 for assigning the code to the dedicated gift token and transmitting the assigned code information to the dedicated gift token information database 110 to be stored therein;

a request dedicated gift token information obtaining unit 125 for obtaining the dedicated gift token information requested from the dedicated access terminal 400;

a dedicated use place designation unit 130 for designating the use place of using the dedicated gift token requested from the dedicated access terminal 400 and transmitting the designated use place information to the dedicated gift token information database 110 to be stored therein;

an use place information database 150 for storing and managing the use place information of using the dedicated gift token and the coupon image information;

a mobile terminal information obtaining unit 160 for obtaining the mobile terminal information obtained the request dedicated gift token information obtaining unit 125;

a dedicated gift token coupon generation unit 170 for generating the dedicated gift token coupon as the coupon image corresponding to the dedicated gift token obtained by the mobile terminal information obtaining unit 160;

a dedicated gift token coupon transmittance unit 180 for transmitting the dedicated gift token coupon generated by the dedicated gift token coupon generation unit 170 to a mobile number of the mobile terminal obtained by the mobile terminal information obtaining unit 160 by means of the message; and

a dedicated gift token management controlling unit 190 for controlling signal flows between each database and each unit.

In the mobile dedicated gift token management system according to another embodiment of the present invention, the dedicated gift token is sold through the dedicated internet access mall for admitting of only access of the dedicated access terminal 400, not the internet homepage of the first embodiment of the present invention.

Here, the request dedicated gift token information obtaining unit 125 serves to obtain the dedicated gift token information requested from the dedicated access terminal 400.

For example, the request dedicated gift token information obtaining unit 125 can obtain the dedicated gift token information such as a kind of the dedicated gift token, a number of the dedicated gift token, a cash charging status, the term of validity, a selling price, an image of the coupon, a logo of the coupon, and a member store information and so on.

Also, the request dedicated gift token information obtaining unit 125 serves to obtain the use place designated by the dedicated use place designation unit 130.

The dedicated use place designation unit 130 serves to designate the use place of using the dedicated gift token requested from the dedicated access terminal 400 and transmit the designated use place information to the dedicated gift token information database 110 to be stored therein.

For example, if the use place is designated as a “Kyobo Bookstore”, the dedicated use place designation unit 130 obtains the corresponding designated information.

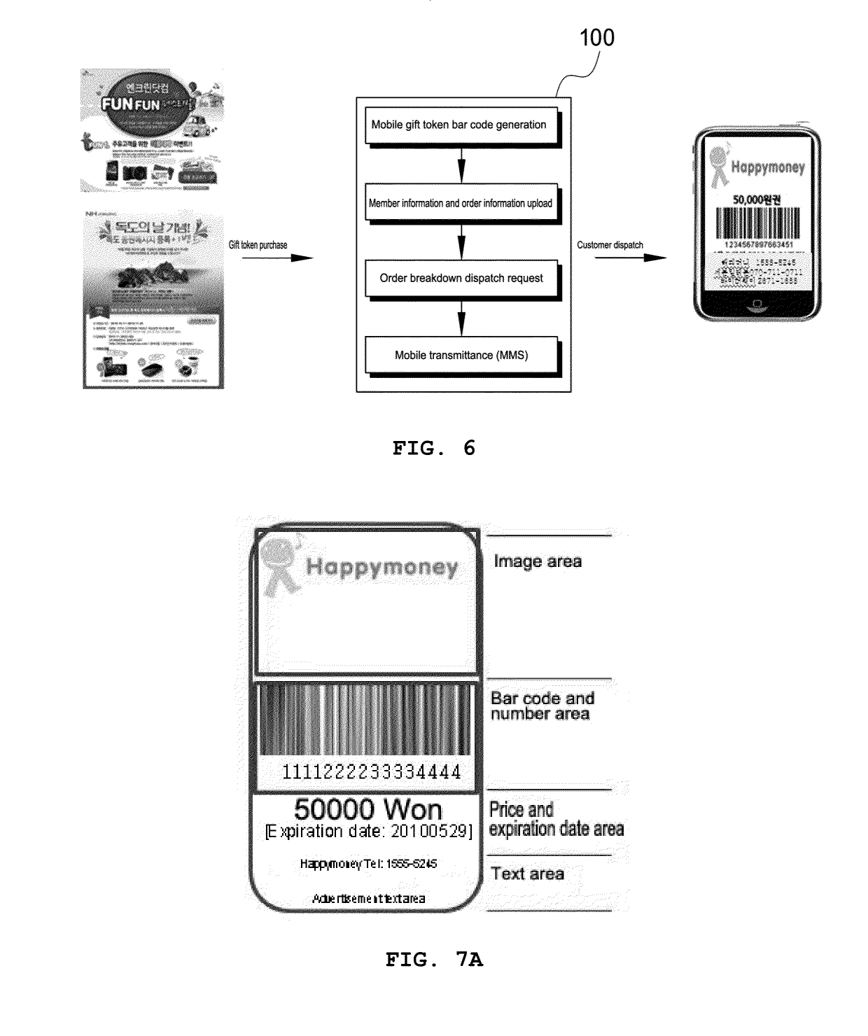

FIG. 6 is an exampling view illustrating a procedure of a mobile dedicated gift token management system according to the present invention.

As shown in FIG. 6, if the purchase of the gift token is requested from the user terminal or the dedicated access terminal, the bar code of the corresponding dedicated gift token is generated and then, the dedicated access customer information or the user information and the order information are stored in the use place information database 150.

Thereafter, where a dispatch of an order breakdown is requested, the MMS (Multimedia Messaging Service) message is transmitted to the corresponding mobile terminal.

Then, the corresponding coupon is outputted through the mobile terminal.

Here, as part of an advertisement of the enterprise, the enterprise logo can be dispatched together with the e-mail.

According to another aspect of the present invention, the dedicated gift token management server 100 further includes an expiration date setting unit (not shown) for setting the term of validity.

According to the set of the term of validity, it can prevent the dedicated gift token from being wrongfully used in an improper deal. Also, in terms of the management thereof, it can set the term of validity for a rapid turnover of capital.

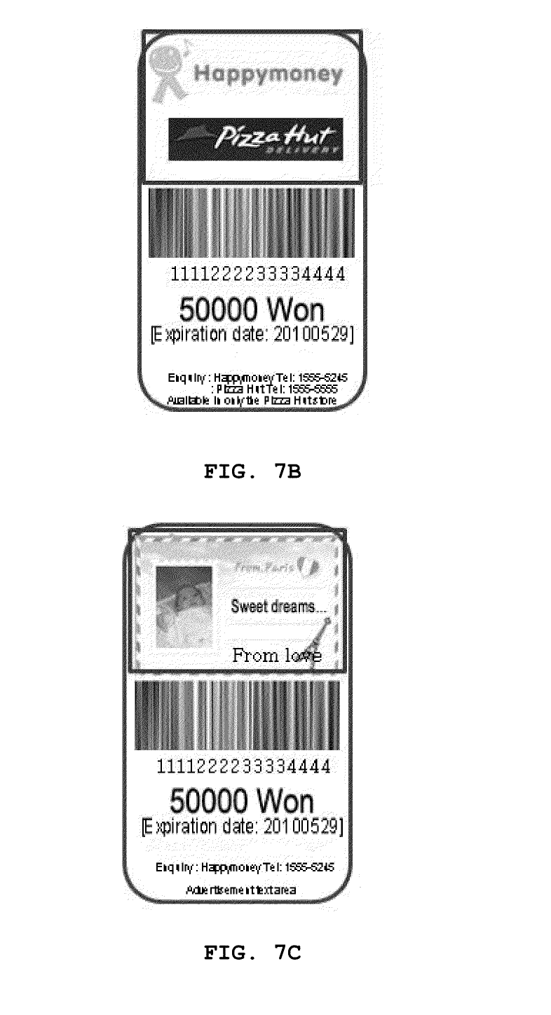

FIG. 7A through FIG. 7C are exampling views illustrating images of the corresponding coupons of sending to the mobile terminal through a mobile dedicated gift token management system according to the present invention.

FIG. 7A illustrates an example of recording the images and sentences in the corresponding area thereof.

As shown in FIG. 7A, the image area includes the logo of the enterprise or the product advertising and so forth and the bar code and the number area includes the bar code image and the number information.

Also, the price and expiration date area includes the corresponding price and the expiration date information.

Moreover, the text area includes various advertising copy or a notice.

FIG. 7B illustrates an example of inserting the image called “Pizza Hut” into the coupon.

According to further another aspect of the present invention, the dedicated gift token management server 100 further includes:

an user designation information obtaining unit (not shown) for obtaining sentences or image information designated by the user terminal 200 connected to the homepage or the dedicated access terminal 400; and

an user designation information matching unit (not shown) for receiving the sentences or the image information obtained by the user designation information obtaining unit and matching them to a predetermined area established within the coupon image generated by the dedicated gift token coupon generation unit 170.

The sentences or the image information designated by the user terminal 200 connected to the homepage or the dedicated access terminal 400 are obtained and they are matched to the predetermined area established within the generated coupon image in advance, thereby making good use of the public relations of the enterprise or the user.

The user designation information obtaining unit serves to obtain the sentences or the image information designated by the user terminal 200 connected to the homepage or the dedicated access terminal 400.

Also, the user designation information matching unit serves to receive the sentences or the image information obtained by the user designation information obtaining unit and match them to a predetermined area established within the coupon image generated by the dedicated gift token coupon generation unit 170.

For example, if the sentences “Sweet dreams . . . ” and “From love” are provided by the user, the sentences are obtained by the user designation information obtaining unit and then, are matched to the image area of the coupon through the user designation information matching unit.

The area information is stored in the dedicated gift token information database 110.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A mobile dedicated gift token management system, comprising:
a dedicated gift token management server for designating a code grant and an use place to a dedicated gift token sold through a dedicated gift token site of a homepage and transmitting a message of a coupon corresponding to the dedicated gift token to a mobile terminal offered in a case that it orders the dedicated gift token though the homepage; and
the mobile terminal for receiving the message from the dedicated gift token management server and outputting a coupon image on a monitor.

2. A mobile dedicated gift token management system as claimed in claim 1, wherein the dedicated gift token management server comprises:
a dedicated gift token information database for storing and managing dedicated gift token information sold through the dedicated gift token site therein;
a dedicated code assignment unit for assigning the code to the dedicated gift token and transmitting the assigned code information to the dedicated gift token information database to be stored therein;
a dedicated use place designation unit for designating the use place of using the dedicated gift token and transmitting the designated use place information to the dedicated gift token information database to be stored therein;
a dedicated gift token information providing unit for providing the dedicated gift token information stored in the dedicated gift token information database to the web server of managing the homepage;
an use place information database for storing and managing the use place information of using the dedicated gift token and the coupon image information;
a mobile terminal information obtaining unit for obtaining the mobile terminal information in a case that it orders the dedicated gift token though the homepage;
a dedicated gift token coupon generation unit for generating the dedicated gift token coupon as the coupon image corresponding to the dedicated gift token obtained by the mobile terminal information obtaining unit;
a dedicated gift token coupon transmittance unit for transmitting the dedicated gift token coupon generated by the dedicated gift token coupon generation unit to a mobile number of the mobile terminal obtained by the mobile terminal information obtaining unit by means of the message; and
a dedicated gift token management controlling unit for controlling signal flows between each database and each unit.

3. A mobile dedicated gift token management system, comprising:
a dedicated gift token management server for designating a code grant and an use place to a dedicated gift token requested from a dedicated access terminal and transmitting a message of a coupon corresponding to the dedicated gift token to a mobile terminal offered through the dedicated access terminal in a case that it orders the dedicated gift token; and
the mobile terminal for receiving the message from the dedicated gift token management server and outputting a coupon image on a monitor.

4. A mobile dedicated gift token management system as claimed in claim 3, wherein the dedicated gift token management server comprises:
a dedicated gift token information database for storing and managing dedicated gift token information sold through the dedicated gift token site therein;
a dedicated code assignment unit for assigning the code to the dedicated gift token and transmitting the assigned code information to the dedicated gift token information database to be stored therein;
a request dedicated gift token information obtaining unit for obtaining the dedicated gift token information requested from the dedicated access terminal;
a dedicated use place designation unit for designating the use place of using the dedicated gift token requested from the dedicated access terminal and transmitting the designated use place information to the dedicated gift token information database to be stored therein;
an use place information database for storing and managing the use place information of using the dedicated gift token and the coupon image information;
a mobile terminal information obtaining unit for obtaining the mobile terminal information obtained the request dedicated gift token information obtaining unit;
a dedicated gift token coupon generation unit for generating the dedicated gift token coupon as the coupon image corresponding to the dedicated gift token obtained by the mobile terminal information obtaining unit;
a dedicated gift token coupon transmittance unit for transmitting the dedicated gift token coupon generated by the dedicated gift token coupon generation unit to a mobile number of the mobile terminal obtained by the mobile terminal information obtaining unit by means of the message; and
a dedicated gift token management controlling unit for controlling signal flows between each database and each unit.

5. A mobile dedicated gift token management system as claimed in claim 1, wherein the mobile terminal comprises:
a message receiving unit for receiving the message from the dedicated gift token management server;
a coupon downloading unit for downloading the corresponding coupon image received from the message receiving unit;
a coupon image outputting unit for outputting the downloaded coupon image on the monitor; and
a coupon storing unit for storing the coupon downloaded through coupon downloading unit therein.

6. A mobile dedicated gift token management system as claimed in claim 3, wherein the mobile terminal comprises:
a message receiving unit for receiving the message from the dedicated gift token management server;
a coupon downloading unit for downloading the corresponding coupon image received from the message receiving unit;
a coupon image outputting unit for outputting the downloaded coupon image on the monitor; and
a coupon storing unit for storing the coupon downloaded through coupon downloading unit therein.

7. A mobile dedicated gift token management system as claimed in claim 2, wherein the message including a callback URL SMS or a WAP PUSH (Wireless Application Protocol Push) is transmitted to a phone number of the desiring mobile terminal in the dedicated gift token coupon transmittance unit.

8. A mobile dedicated gift token management system as claimed in claim 4, wherein the message including a callback URL SMS or a WAP PUSH (Wireless Application Protocol Push) is transmitted to a phone number of the desiring mobile terminal in the dedicated gift token coupon transmittance unit.

9. A mobile dedicated gift token management system as claimed in claim 2, wherein the dedicated gift token management server further comprises an expiration date setting unit for setting the term of validity.

10. A mobile dedicated gift token management system as claimed in claim 4, wherein the dedicated gift token management server further comprises an expiration date setting unit for setting the term of validity.

11. A mobile dedicated gift token management system as claimed in claim 2, wherein the dedicated gift token management server further comprises:
an user designation information obtaining unit for obtaining sentences or image information designated by the user terminal connected to the homepage; and
an user designation information matching unit for receiving the sentences or the image information obtained by the user designation information obtaining unit and matching them to a predetermined area established within the coupon image generated by the dedicated gift token coupon generation unit.

12. A mobile dedicated gift token management system as claimed in claim 4, wherein the dedicated gift token management server further comprises:
an user designation information obtaining unit for obtaining sentences or image information designated by the dedicated access terminal; and
an user designation information matching unit for receiving the sentences or the image information obtained by the user designation information obtaining unit and matching them to a predetermined area established within the coupon image generated by the dedicated gift token coupon generation unit.
